(19) United States
(12) Patent Application Publication
(10) Pub. No.: US 2013/0149586 A1
(43) Pub. Date: Jun. 13, 2013

(54) BATTERY CELL

(71) Applicant: Sung-Ho HONG, Yongin-si (KR)

(72) Inventor: Sung-Ho HONG, Yongin-si (KR)

(73) Assignee: SAMSUNG SDI CO., LTD., Yongin-si (KR)

(21) Appl. No.: 13/569,388

(22) Filed: Aug. 8, 2012

Related U.S. Application Data
(60) Provisional application No. 61/568,997, filed on Dec. 9, 2011.

(51) Int. Cl. H01M 2/04; H01M 2/18

(52) U.S. Cl. 429/138

(57) ABSTRACT

A battery cell including an electrode assembly, a pouch accommodating the electrode assembly, a electrode lead connected to the electrode assembly and extending to an external portion of the pouch, a slit portion that the electrode lead pass through and an insulator covering at least a portion of the pouch and the electrode lead.

### CLAIM OF PRIORITY

This application claims priority to and the benefit of Provisional Application No. 61/568,997, filed on 9 Dec. 2011, in the United States Patent and Trademark Office, the entire content of which is incorporated herein by reference.

### BACKGROUND OF THE INVENTION

1. Field of the Invention

The present disclosure generally relates to a battery cell, and more specifically to the single cells that may be incorporated into a battery pack.

2. Description of the Related Art

Recently, a battery cell has been widely used as a power source of the portable electronic device. In addition, as a portable electronic device is used in various fields, demand for high-capacity battery cell increases.

The above information disclosed in this Related Art section is only for enhancement of understanding of the background of the invention and therefore it may contain information that does not form the prior art that is already known to a person of ordinary skill in the art.

### SUMMARY OF THE INVENTION

The present disclosure relates to a battery cell and such constituent components such as a single cell that will sometimes be referred to herein simply as a battery cell having an improved safety by providing an integrally formed insulator to an upper portion of a pouch.

In addition, the present disclosure is to provide a battery cell to increase productivity and to reduce quality variation by forming an existing insulator formed as various parts as an integrally formed type. An aspect of the present invention includes a battery cell having an electrode assembly with a first and second electrode lead. This battery cell may include a pouch to accommodate the electrode assembly; and an insulator cover coupled to an end of the pouch having a first slit portion that the first electrode lead extends through and a second slit portion that the second electrode lead extends through.

The insulator cover may be composed of a single structure in which the insulator cover includes a corresponding surface that is attached to the end of the pouch, said corresponding surface having an oval shape with a short axis and a long axis or a rectangular shape having a long side and a short side.

The insulator cover may also include at least two bending lines on opposite sides of and parallel to the long axis or the long side.

Further, the first and second slit portions may be located between a two of the at least two bending lines. Still further, both of the two bending lines may include vertical extensions that are bent at a predetermined angle to a plane containing the two bending lines and the first and second slits.

In addition, each of the vertical extensions may be attached at approximately another predetermined angle to the corresponding surface of the insulator cover.

Still further, the first and second slits may be located on a line located approximately midpoint between the short axis or the short side of the insulator cover.

Still further, the first and second slits may be located on different lines between the short axis or the short side of the insulator cover and parallel to the long axis or the long side.

Also, the distance between two of the at least two bending lines may be approximately equal to the width of the first or second slits portion.

In another aspect of the present invention, the first and second slits may be located on opposite sides of a line located approximately midpoint between the short axis or the short side of the insulator cover.

Further, the distance between a two of the at least two bending lines may be approximately equal to the width of the first and second slit portions.

Still further, insulating tape may surround a base of the first electrode lead and a base of the second electrode lead, the base of the first electrode lead and the base of the second electrode lead are formed at the point of contact with the end of the pouch.

Also, the insulating tape may be surrounded by a boundary portion projecting from the end of the pouch.

The distance between the first and second slits and the corresponding surface may be greater than the height of the boundary portion.

The insulator cover may include an adhesive layer located between the insulator cover and the pouch.

The adhesive layer may be a double-sided tape.

The first slit may be located on a side of a line located approximately midpoint between the short axis or the short side of the insulator cover.

Further, the second slit may be located on the line located approximately midpoint between the short axis or the short side of the insulator cover.

In another aspect of the present invention, the first slit may be located on a side of a line partly overlapping a midpoint line between the short axis or the short side of the insulator cover, the second slit may be located on another side of a line partly overlapping the midpoint line between the short axis or the short side of the insulator cover and on an opposite side to the first slit,

The insulator may be a double-sided tape and may be a tape consisting at least one of selected from tape aromatic polyamide based-compound, Polyimide-based compound and polypropylene-based compound.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a an oblique view of a battery cell according to an exemplary embodiment of the present disclosure;

FIG. 2 is an exploded view of FIG. 1;

FIG. 3a is an enlarged an oblique view of insulator;

FIG. 3b is a plan view of FIG. 3a;

FIG. 4 is a an oblique view of a battery cell according to another embodiment of the present disclosure;

FIG. 5a is an enlarged view of FIG. 4;

FIG. 5b is a plan view of a FIG. 5a;

FIG. 6 is a an oblique view of a battery cell according to another embodiment of the present disclosure;

FIG. 7a is an enlarged an oblique view of FIG. 6; and

FIG. 7b is a plan view of a FIG. 7a.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different from one another, are not necessarily mutually exclusive. For example, a particular feature, structure, and characteristic described herein in connection with one embodiment may be implemented within other embodiments without departing from the spirit and scope of the present invention. Also, it is to be understood that the locations or arrangements of individual elements in the embodiment may be changed without separating the spirit and scope of the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

The following detailed description is, therefore, not to be taken in a limiting sense, and the scope of the invention is defined only by the appended claims that should be appropriately interpreted along with the full range of equivalents to which the claims are entitled. In the drawings, like reference numerals identify identical or like elements or functions through the several views.

Numerous studies have been conducted to improve safety in batteries. In these studies, the battery cell can vary significantly according to shape of the battery cell itself and may include a pouch type battery cell, a square shape battery cell or a cylindrical battery cell.

In the pouch type battery cell, in order to prevent a short caused by non-insulation of the pouch or a short caused by interference of an electrode lead, the entire bare cell is isolated using an insulator.

In general, an upper insulator and a lower insulator are composed of two-parts. Therefore, the above-mentioned structure results in inefficiency and quality variation in terms of productivity in an alignment problem of the two-parts caused by a manual labor.

The present disclosure will be described with reference to an accompanying drawing.

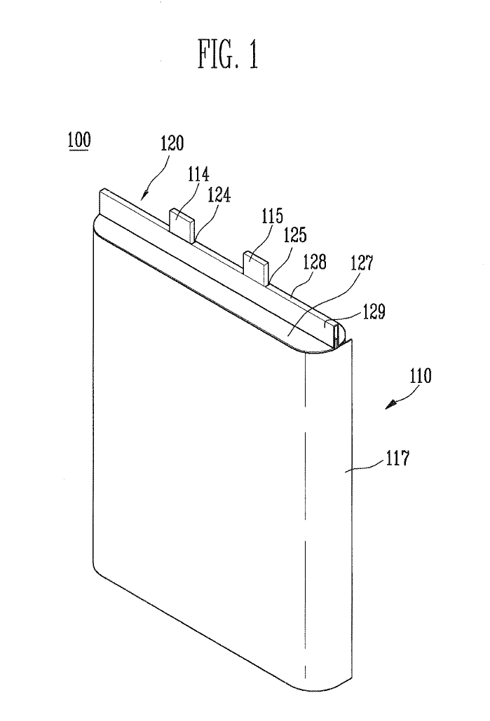

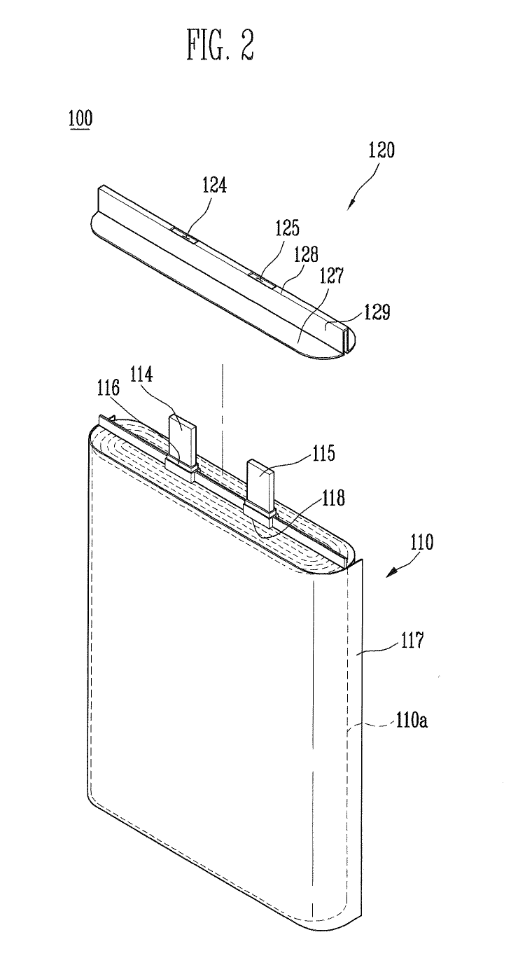

FIG. 1 is a an oblique view of a battery cell according to a first embodiment of the present disclosure. FIG. 2 is an exploded perspective view of FIG. 1 .

Referring to FIGS. 1 to 2, a battery cell according to exemplary embodiment of the present invention an electrode assembly 110a, a pouch 117 accommodating the electrode assembly, an electrode lead 114, 115 connected with the electrode assembly and extending to the outside of the pouch 117, a slit section 124, 125 that the electrode 114, 115 pass through and an isolator 120 covering at least portion of the pouch 117 and the electrode lead 114, 115.

The electrode assembly 110a may include a first poll plate (not shown) and a second poll plate (not shown) and a separator (not shown) interposed between the poll plate. When the first poll plate is an anode plate and the second poll plate is a cathode plate, ions or electrons move between the first poll plate and second poll plate, thereby generating an electro-chemical energy.

The first poll plate may be formed by coating an anode active material on both surfaces or signal surface of the anode active material.

Generally, the anode active material is a material having a high conductivity, which is not particularly limited if a chemical-induced change does not occur.

In addition, the anode active material contains a layered compound of lithium.

The second poll plate may be formed by coating the cathode active material on the one surface or both sides of the anode current collector.

When the poll plate is an opposite polarity, the separator may be interposed between the poll plates, so that the poll plates are in direct contact to prevent a short.

For example, the separator may be formed of polymeric material and the insulating thin film having high ion permeability and a mechanical strength may be used.

Meanwhile, the pouch 117 accommodates and seals the electrode assembly 110a and electrolyte (not shown).

The electrolyte housed in the pouch 117 may include lithium salts serving as a supply source of lithium ion and a non-aqueous organic solvent serving as a medium for the movement of ions involved in an electro-chemical reactions.

The first poll plate (not shown) and the second poll plate (not shown) including the electrode assembly 110a reacts with the electrolyte to generate electro-chemical energy and the generated electro-chemical energy may be transferred through the first electrode 114 and the second electrode lead 115 to the outside

The first poll plate and the second poll plate reacts with the electrolyte to generate electro-chemical energy.

In addition, a part which the first electrode 114 and the second electrode 115 extend to the upper end portion of the pouch 117 is provide with an insulating tape 116 for preventing a short circuit with the pouch 117 including the metal.

As such, the first poll plate and second poll plate and separator is wound to manufacture the electrode assembly 110a such as the present invention, but is not limited to this configuration and different types electrode assemblies may manufactured by various scheme stacking the first poll plate and second plate and the separator.

The pouch 117 accommodating the electrode assembly 110a is formed by inserting the metal such aluminum (Al) between the high molecule layer composed of the high molecule layer. The pouch 117 may be a square shape but is not limited to this configuration.

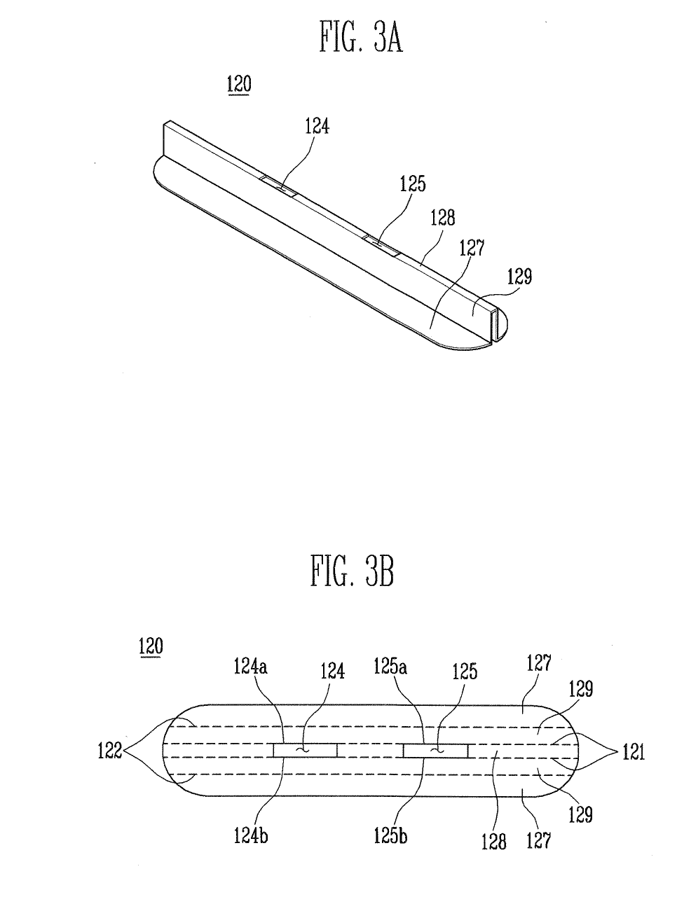

The insulator 120 according to an exemplary embodiment of the present invention will be described with reference to FIGS. 3A and 3B.

FIG. 3a is an expanded oblique view of insulator 120. FIG. 3b is a deployed view of FIG. 3a.

Referring to 3a, the insulator 120 according to an exemplary embodiment has an integral shape covering an area in which the boundary 118 of the first electrode lead 114 or the second electrode 115 and the pouch 117 may be formed.

Herein, the insulator 120 may include a first slit portion 124 and a second slit 125 that the first electrode lead 114 and the second lead 125 correspond and pass through.

The flat surface 127 facing the pouch 117 of the insulator 120 may be in oval shape having the long axis and the short axis as the embodiment of the present invention, but is not limited to this shape and may have various shapes.

For example, the flat surface may be a rectangular having the long side and the short side.

Referring to FIG. 3b, the insulator 120 according to an exemplary embodiment of the present invention includes the bending lines 121, 122 parallel to the long axis.

Among this, the first bending line 121 may include the longitudinal outline of the first slit section 124 or the second slit portion 125.

That is, the first bending line 121 is made of two, which is formed to be consistent with the first virtual extension connecting one side 124a of the first slit portion 124 and one side 125a of the outline of the second slit section 125 and to be consistent with the second virtual extension connecting other side 124b of the outline of the first slit portion section 124 and other 125b of the outline of the second slit section 125.

Meanwhile, the second bending line 122 is formed to be consistent with one side of the first electrode lead 114 or the second electrode lead 115 and the boundary 118 of the pouch 117 or other side of the first electrode lead and the second electrode lead 115 and the boundary 118 of the pouch 117 is formed to be consistent and being made of two (see FIG. 2).

Herein, the insulator 120 may further include an adhesive layer (not shown), wherein the adhesive layer is provide between the insulator and the pouch 117.

In addition, the insulator 120 is the double-sided tape which is not provided with the adhesive layer, in which case the insulator 120 may be a tape consisting at least an aromatic polyamide based-compound, Polyimide-based compound and polypropylene-based compound.

As described above, the pouch 117 accommodating the electrode assembly may be formed by inserting metal such as aluminum (Al) between molecule layers of the pouch 117.

Therefore, in some cases, the metal within the pouch 117 may be exposed. However, as an embodiment of the present invention, when the portion of the pouch 117 and the electrode lead 115 is covered by the integrally formed insulator 120, a exposure of the metal within the pouch can be prevented.

Therefore, the battery cell having improved safety is provided. In addition, by forming an existing insulator as a part of an integral form, improved productivity and reduced quality variation is possible.

The insulator 120 according to another embodiment of the present disclosure will be mainly described with regard to difference from the previous embodiment.

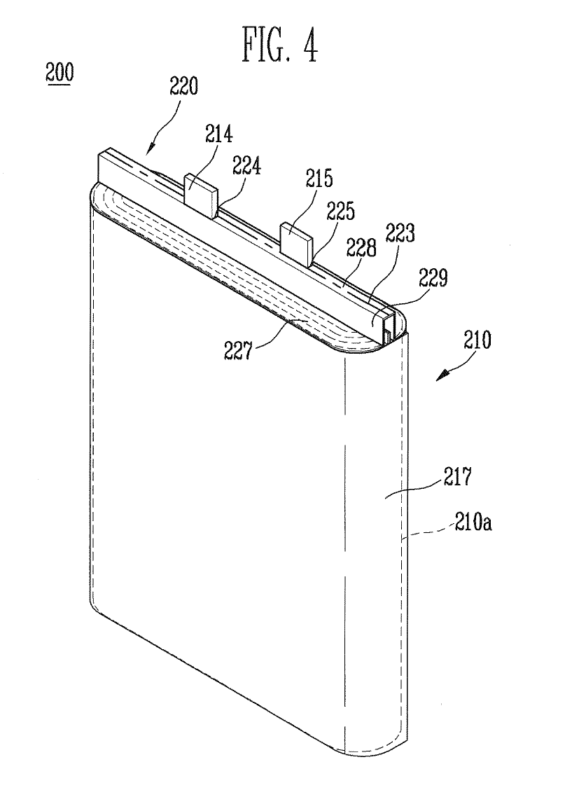

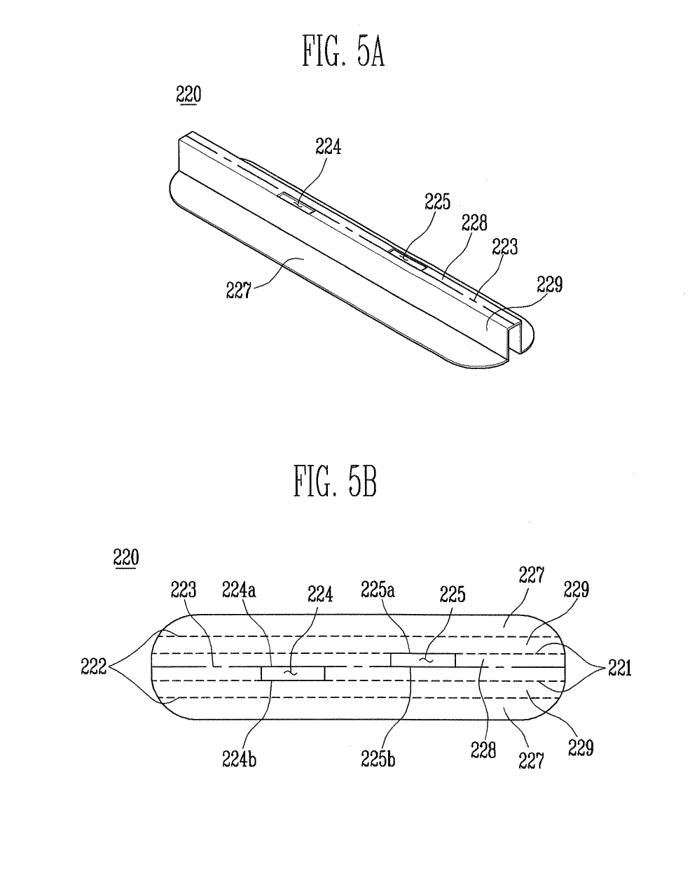

FIG. 4 is a perspective view of a battery cell 200 according to another embodiment of the present invention. FIG. 5a is an expansion perspective view of FIG. 4.

Referring to FIG. 4, the pouch 217 according to the this embodiment accommodates and seals the electrode assembly 210a and electrolyte (not shown).

The electrolyte accommodated in the pouch 217 may include lithium salts serving as a supply source of lithium ions and a non-aqueous organic solvent serving as a medium for the movement of ions involved in an electro-chemical reactions.

The first poll plate (not shown) and the second poll plate (not shown) forming the electrode assembly 210a react with the electrolyte to generate electro-chemical energy and the generated electro-chemical energy may be transferred through the first electrode 214 and the second electrode lead 215 to the exterior of the battery.

In addition, a part which the first electrode lead 214 and the second electrode lead 215 extend to the upper end portion of the electrode assembly 210a is provide with an insulating tape (not shown) for preventing a short circuit with the pouch 217 including metal.

Herein, the first electrode lead 214 and the second electrode lead 215 according to the present embodiment of the present invention are not located on the same line and are staggered by a thickness of the first electrode lead 214 and the second electrode lead 215, unlike the previous embodiment.

Referring to FIG. 5, a sealing part 228 of the insulator 220 according to the second embodiment of the present invention includes a first slit portion 224 and a second slit 225 which the first electrode lead 214 and the second lead 215 corresponding pass through as in the previous embodiment.

The flat surface 227 of the insulator 220 facing the bare cell 310 may be in an oval shape having the long axis and the short axis in the embodiments of the present disclosure but may has various shapes, without being limited to the oval shape.

For example, the flat surface 227 may be in a rectangular shape having the long side and the short side (see FIG. 4).

Further, an extension part 229 is provided between the flat surface 227 and the sealing part 228 to cover the first electrode lead 214, the second electrode lead 215, and the electrical insulating tape (not shown).

Referring to FIG. 5, the insulator 220 according to this embodiment of the present disclosure includes the bending lines 221, 222 parallel to the long axis and a third extension line 223.

First, a third virtual extension 223 connecting one side 224a of an outline of the first slit section 224 and other side 225b of a outline of the second slit section 225 is a straight line.

That is, the first electrode 214 and the second electrode lead 215 according to this embodiment of the present invention is not located on the same line and is staggered by a thickness of the first electrode lead 214 or the second electrode lead 215, unlike the first embodiment and the third extension line 223 is a straight line.

The first bending line 221 is made of two, which is spaced as much as a thickness from a center of the third extension line 223 to the first electrode lead 214 or the second electrode lead 215.

Meanwhile, the second bending line 222 is formed to be consistent with the boundary of the first electrode lead 214 or the second electrode 215 and the pouch 217.

That is, the second line 222 is made of two, which the boundary of one side of the first electrode 214 or the second electrode 215 and the pouch 217 is formed to be coincident or the boundary of other side of a second electrode 215 and the pouch 217 is formed to be coincident (see FIG. 4).

According to the battery cell 200 of the this embodiment, alignment of the first lead 214 and a second electrode 215 is easier than the prior embodiment.

Even if a task baseline is slightly skewed or the pouch located on one side of the cathode lead is exposed during the attachment process as a worker applies pressure to expose the pouch, thereby preventing a short circuit of battery cell because the insulator can slightly cover the side of the second lead, which is the cathode lead, thereby improving productivity and reducing quality variation.

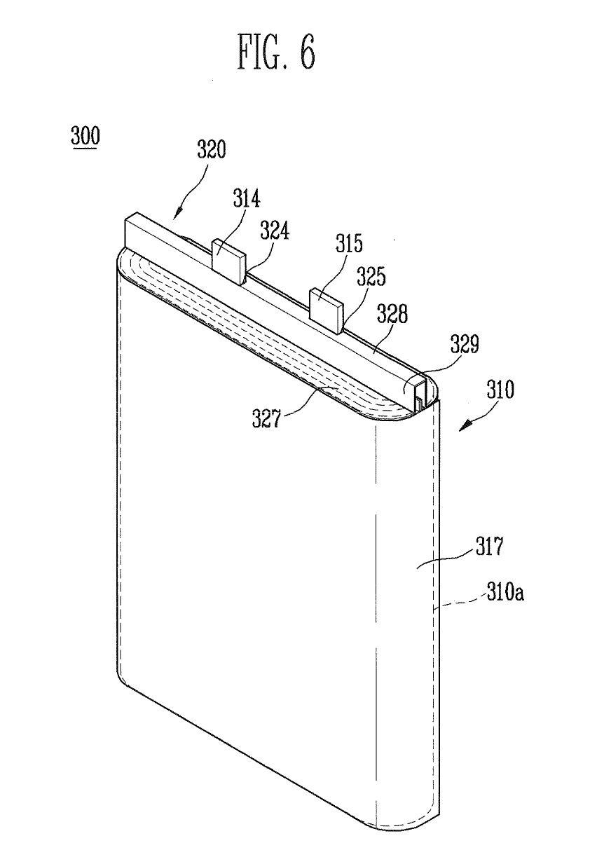

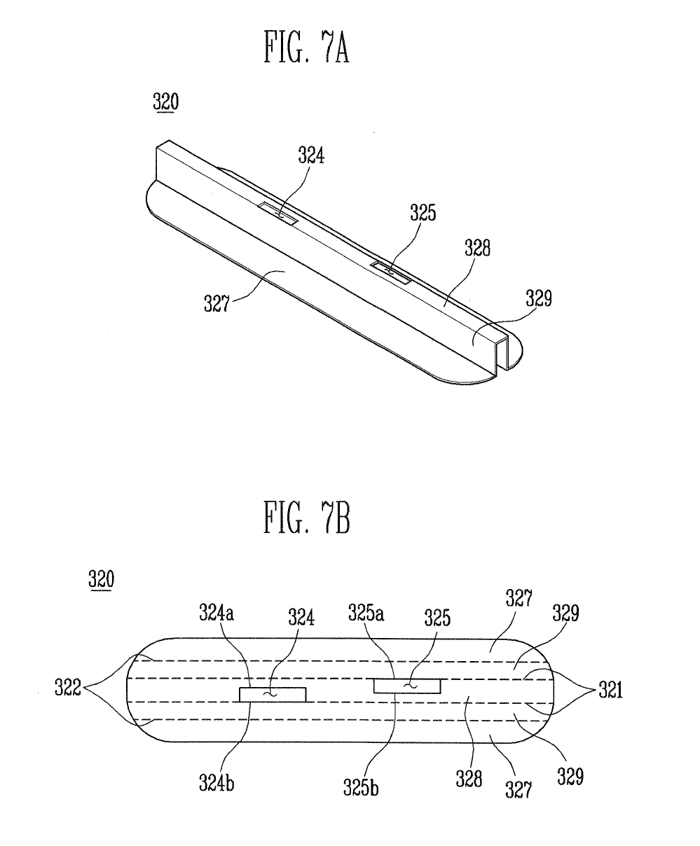

Hereinafter, an insulator 320 constructed according to another embodiment of the present disclosure will be described with reference to FIGS. 6 through 7b, focusing on differences from those of the prior two embodiments.

FIG. 6 is a perspective view of a battery cell 300 constructed according to another embodiment of the present disclosure, FIG. 7A is an enlarged perspective view of the insulator of FIG. 6, and FIG. 7b is a plan view of FIG. 7a.

Referring to FIG. 6, the pouch 317 according to this embodiment accommodates and seals a bare cell including the electrode assembly 310a and an electrolyte (not shown) in the same manner as those in the first and second embodiments. The electrolyte accommodated in the pouch 317 may include a lithium salt serving as a supply source of lithium ions and a non-aqueous organic solvent serving as a medium for the movement of ions involved in an electro-chemical reaction. A first pole plate (not shown) and a second pole plate (not shown) forming the electrode assembly 310a will react with the electrolyte to generate electro-chemical energy and the generated electro-chemical energy may be transferred to the outside through the first electrode lead 314 and the second electrode lead 315. In addition, parts of the first electrode lead 314 and the second electrode lead 315 which project out from the upper end portion of the electrode assembly 310a are provided with an insulating tape (not shown) for preventing the creation of a short circuit with the pouch 317 including metal. Herein, unlike in the embodiment corresponding to FIGS. 2-3B, the first electrode lead 314 and the second electrode lead 315 according to this embodiment are not located in the same line. Further, unlike the prior embodiment, the first electrode 314 and the second electrode lead 315 are not alternately disposed. In this embodiment, the first electrode lead 314 and the second electrode lead 315 are disposed such that assumable extension areas of the first electrode lead 314 and the second electrode lead 315 partly overlap with each other.

Referring to FIG. 7a, a sealing part 328 of the insulator 320 according to this embodiment of the present invention may include a first slit portion 324 and a second slit 325 which the first electrode lead 314 and the second electrode lead 315 correspondingly pass through, respectively, as in the prior two embodiments.

The flat surface 327 of the insulator 320 facing the bare cell 310 may be in an oval shape having the long axis and the short axis in the embodiments of the present disclosure but may has various shapes without being limited to the oval shape. For example, the flat surface 327 may be in a rectangular shape having the long side and the short side.

Further, an extension part 329 is provided between the flat surface 327 and the sealing part 328 to cover the first electrode lead 314, the second electrode lead 315, and the insulating tape (not shown).

Referring to FIG. 7b, the insulator 320 according to the third embodiment of the present disclosure includes bending lines 321 and 322 parallel with the long axis.

Unlike in the embodiment shown in FIGS. 2-3B, the first electrode lead 314 and the second electrode lead 315 are not located in the same line in the third embodiment. Further, unlike in the second embodiment, the first electrode 314 and the second electrode lead 315 are not alternately disposed. In this embodiment, the first electrode lead 314 and the second electrode lead 315 are disposed such that assumable extension areas of the first electrode lead 314 and the second electrode lead 315 partly overlap with each other.

The first bending lines 321 come in contact with the extension parts 329 and are formed of two bending lines, one of which is formed to include one border of the first electrode lead 314 in the lengthwise direction of the first electrode lead 314 and the other of which is formed to include one border of the second electrode lead 315.

Meanwhile, the second bending lines 322 may be formed to correspond to the boundaries between the first electrode lead 314 or the second electrode 315 and the bare cell. That is, the second bending lines 322 are formed of two bending lines, one of which is formed to correspond to the boundary between one side of the first electrode lead 314 or the second electrode lead 315 and the bare cell 310 and the other which is formed to correspond to the boundary between another side of the first electrode lead 314 or the second electrode lead 315 and the bare cell 310.

In the battery cell 300 according to this embodiment, it is easier to align the first electrode lead 314 and the second electrode lead 315 than in the embodiment illustrated in FIGS. 2-3b. Further, even though a task baseline for an attachment process slightly inclines or one portion of the pouch at the cathode lead is exposed by pressure applied by a worker to the insulator, the insulator 320 can slightly cover a side of the second electrode lead, the cathode lead, thereby preventing short of the battery cell. In addition, the insulator 320 is properly aligned on and attached to the upper side of the bare cell 310 to reduce errors in the attachment process, thus improving productivity and decreasing quality variations.

As described above, according to the present invention, the upper surface of the pouch is covered with the integral type insulator so that an exposure of metal within the case is prevented, thereby providing a battery cell having a improved safety.

In addition, by the existing insulator formed in various parts as an integral form, thereby improving productivity and reducing a quality variation.

As described above, according to the present disclosure, the upper surface of the pouch is covered with the integral type insulator so that an exposure of metal within the case is prevent, thereby providing a battery cell having a improved safety.

In addition, by forming the existing insulator formed as various parts as an integral form, thereby improving productivity and reducing a quality variation.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery cell having an electrode assembly with a first and second electrode lead, comprising:
a pouch to accommodate the electrode assembly; and
an insulator cover coupled to an end of the pouch having a first slit portion that the first electrode lead extends through and a second slit portion that the second electrode lead extends through.

2. The battery cell recited in claim 1, wherein the insulator cover is composed of a single structure.

3. The battery cell recited in claim 2, wherein the insulator cover includes a corresponding surface that is attached to the end of the pouch, said corresponding surface having an oval shape with a short axis and a long axis or a rectangular shape having a long side and a short side.

4. The battery cell recited in claim 3, wherein the insulator cover includes at least two bending lines on opposite sides of and parallel to the long axis or the long side.

5. The battery cell recited in claim 4, wherein the first and second slit portions are located between a two of the at least two bending lines.

6. The battery cell recited in claim 5, wherein both of the two bending lines include vertical extensions that are bent at a predetermined angle to a plane containing the two bending lines and the first and second slits.

7. The battery cell recited in claim 6, wherein each of the vertical extensions is attached at approximately another predetermined angle to the corresponding surface of the insulator cover.

8. The battery cell recited in claim 1, wherein the first and second slits are located on a line located approximately midpoint between the short axis or the short side of the insulator cover.

9. The battery cell recited in claim 1, wherein the first and second slits are located on different lines between the short axis or the short side of the insulator cover and parallel to the long axis or the long side.

10. The battery cell recited in claim 4, wherein the distance between two of the at least two bending lines is approximately equal to the width of the first or second slits portion.

11. The battery cell recited in claim 1, wherein the first and second slits are located on opposite sides of a line located approximately midpoint between the short axis or the short side of the insulator cover.

12. The battery cell recited in claim 4, wherein the distance between a two of the at least two bending lines is approximately equal to the width of the first and second slit portions.

13. The battery cell recited in claim 1, wherein insulating tape surrounds a base of the first electrode lead and a base of the second electrode lead, the base of the first electrode lead and the base of the second electrode lead are formed at the point of contact with the end of the pouch.

14. The battery cell recited in claim 13, wherein the insulating tape is surrounded by a boundary portion projecting from the end of the pouch.

15. The battery cell recited in claim 14, wherein a distance between the first and second slits and the corresponding surface is greater than the height of the boundary portion.

16. The battery cell recited in claim 1, wherein the insulator cover includes an adhesive layer located between the insulator cover and the pouch.

17. The battery cell recited in claim 1, wherein the adhesive layer is a double-sided tape.

18. The battery cell recited in claim 1, wherein the first slit is located on a side of a line located approximately midpoint between the short axis or the short side of the insulator cover.

19. The battery cell recited in claim 18, wherein the second slit is located on the line located approximately midpoint between the short axis or the short side of the insulator cover.

20. The battery cell recited in claim 1, wherein the first slit is located on a side of a line partly overlapping a midpoint line between the short axis or the short side of the insulator cover, the second slit is located on another side of a line partly overlapping the midpoint line between the short axis or the short side of the insulator cover and on an opposite side to the first slit.

21. The battery cell recited in claim 1, wherein the first and second slits are laterally offset from one another.
